(19) United States
(12) Patent Application Publication
(10) Pub. No.: US 2002/0181873 A1
(43) Pub. Date: Dec. 5, 2002

(54) Multimode coupler system

(76) Inventors: Jesse Anderegg, Salt Lake City, UT (US); Forrest Williams, Sandy, UT (US); Yuri Grapov, Sandy, UT (US); Allen Tanner, Sandy, UT (US)

Correspondence Address: Clifton W. Thompson, THORPE, NORTH & WESTERN, L.L.P., P.O. Box 1219, Sandy, UT, 84091-1219, US

(21) Appl. No.: 09/872,200

(22) Filed: May 30, 2001

(51) Int. Cl. G02B 6/26

(52) U.S. Cl. 385/39; 385/43; 385/45

(57) ABSTRACT

A multimode optical coupler comprising a first optical fiber having a polished face on its side, and a second optical fiber having an end which is polished at an angle. The angled polished end of the second optical fiber is disposed in mating alignment with the polished face of the first optical fiber, and light energy propagating through the second fiber can pass into the first fiber. A series of such couplers may be interconnected in a network so as to combine the energy of many light sources for a desired power level in a single optical fiber.

### BACKGROUND

1. Field of the Invention

This invention relates to couplers for optical conductors. More particularly, the present invention relates to a high power multimode coupler having a single-ended pump fiber with a polished angle, and systems and networks comprised of one or more such multimode couplers.

2. Discussion of the Art

There are several types of optical waveguides. The most common types are single-mode and multimode optical fibers. Single-mode fibers have very small cores, typically in the range of 4 μm to 10 μm in diameter, while multimode fibers have relatively large cores, typically in the range of 50 μm to 1000 μm in diameter. The difference in core diameter for the two types of optical fiber dictates a difference in the manner in which light propagates through the fiber of a given type. Because the core dimensions of a single-mode optical fiber are comparable to the wavelength of light that is contained within the fiber, the propagation of light in a single-mode fiber is governed, generally speaking, by physical optics. Light propagation in multimode optical fibers, on the other hand, is sufficiently modeled, generally speaking, by geometrical optics. Thus, single-mode optical fibers may be regarded as wave-propagating structures, while multimode optical fibers are often referred to as “light pipes” (see, for example, A. H. Cherin, An Introduction to Optical Fibers, McGraw Hill, New York, 1983).

There are advantages and disadvantages to using both types of optical fibers. Since a single-mode optical fiber has a very small core, it is very difficult to efficiently couple light directly into a single-mode fiber. However, using a single-mode optical fiber ensures that the beam quality of light transmitted via single-mode fiber is not degraded by propagation in the fiber, as can be the case when using multimode optical fiber. Conversely, because of their much larger cores, multimode optical fibers are much simpler to couple to compared to single-mode fibers.

Couplers, and amplifiers, etc. for use with both single mode and multimode optical fibers are well known. For example, in optical communications, amplifiers are needed at regular intervals to boost a signal. The physical spacing of these amplifiers depends in part upon the amount of power which can be injected into a given optical conductor with a single pumping source. Optical couplers and amplifiers typically involve coupling optical fibers together in such a way that light energy traveling in one fiber is transmitted into the other. To accomplish this, a typically flat, semi-elliptical face, facet, or polished flat is formed on the side of each of two fibers, and these faces are aligned with and disposed against each other, usually, but not always, with an optically neutral lubricant disposed therebetween. Light energy is transmitted or “pumped” into the first fiber, which is usually termed a “pumping” fiber, from a source such as a laser diode or solid state laser. Upon reaching the polished face, a portion of the light propagating through the pumping fiber transfers into the second fiber, the “signal”fiber, increasing the energy therein.

In many optical amplifiers, the portion of the signal fiber in the vicinity of the polished flat is doped with lasing substances such as neodymium-ytrium, or erbium. The light energy which is pumped through the coupler increases the energy of these lasing substances, such that when a signal in the signal fiber passes through the doped region, this signal stimulates light emissions from the lasing substance at the frequency of the signal. In this way a weak signal can be strengthened using the light from a pumping source.

In many amplifiers, the direction of propagation of the pumping energy is irrelevant. All that matters is that energy is transferred into the second fiber in the doped region. However, in some applications it may be desirable to pump large amounts of light energy into a fiber in a single direction. For example, it may be desirable to combine the energy of several pumping fibers into one pumping fiber. Similarly, in medicine, surgical lasers and cauterizing tools frequently use optical fibers to transmit high power light energy. Unfortunately, given the difficulty of coupling large amounts of light energy into single fibers, these devices typically employ bundles of fibers or multiple amplifying couplers in order to deliver the desired amount of energy. There are other applications for fiber optics wherein it is desirable to pump a large amount of light energy into a single fiber in one direction.

### SUMMARY

Briefly, and in general terms, the invention includes a multimode optical coupler comprising a first optical fiber having a polished face on its side, and a second optical fiber having a distal end which is polished at an oblique angle relative to the longitudinal axis of the fiber. The angled surface of the second optical fiber is disposed in mating alignment with the polished face of the first optical fiber, such that light energy propagating through the second fiber can pass into the first fiber with minimal loss. Light sources can be connected to the proximal ends of the first fiber and the second fiber, such that the light energy propagating in both fibers is combined in the first fiber in a light propagating direction, the light energy propagating in the first fiber thereafter having substantially the power of the two light streams combined. The coupler allows a single multimode optical fiber to transmit the power which would ordinarily be associated with multiple fibers.

In accordance with a more detailed aspect of the present invention, A series of such couplers can be interconnected in a network or tree arrangement so as to combine the energy of many light sources into one fiber for a desired power level. The combined light energy may then be used directly, such as for a cutting tool, or may be coupled into an optical device such as an amplifier for amplification of a communications signal.

In accordance with another more detailed aspect of the present invention, The substrates of the two fibers may be moveably coupled together, such that the coupling alignment of the fibers may be adjusted to change the coupling efficiency.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a side cross-sectional view of a conventional prior art fiber optic coupler interconnected to two pumping sources and a signal carrying optical fiber;

FIG. 2 is a side cross-sectional view of a multimode coupler according to the present invention interconnected to two pumping sources and a signal carrying optical fiber;

FIG. 3 is a schematic diagram illustrating a network configured for combining light energy from many pumping sources into a single fiber using the multimode coupler of FIG. 2;

FIG. 4a is a side cross-sectional view, taken along line 4a-4a in FIG. 4b, of a multimode coupler which is configured to be tunable; and

FIG. 4b is a top cross-sectional view, taken along line 4b-4b in FIG. 4a, of the tunable multimode coupler of FIG. 4a.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein which would occur to one skilled in the relevant art and having possession of this disclosure are to be considered within the scope of the invention.

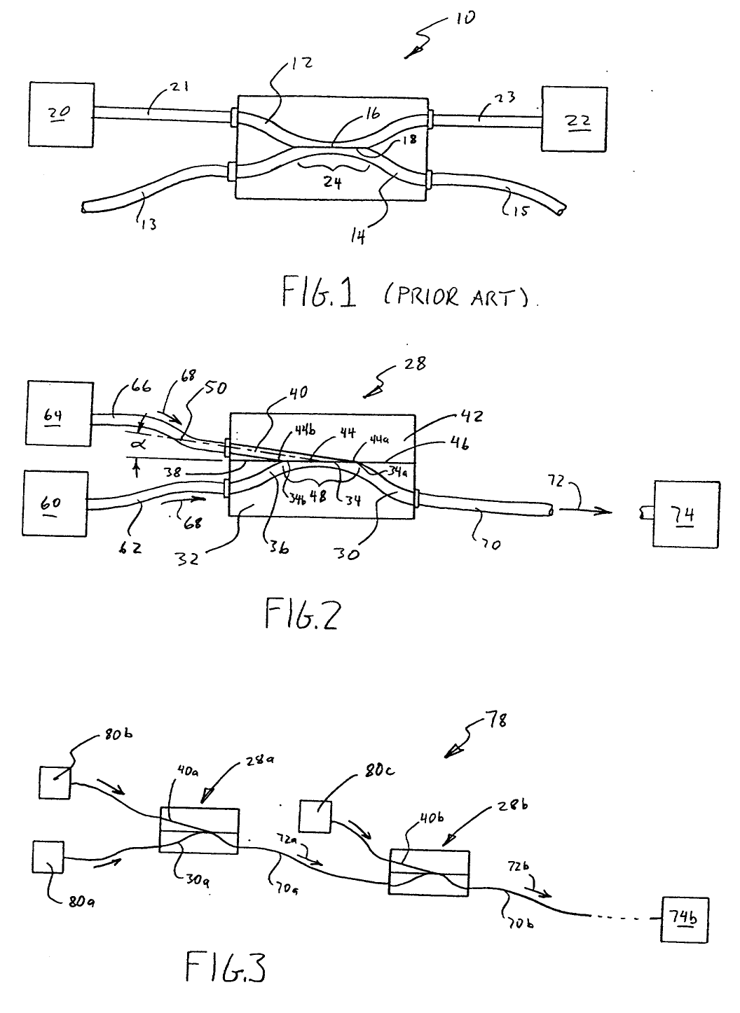

Referring to FIG. 1 a conventional prior art optical coupler 10 generally comprises a first optical fiber 12, and a second optical fiber 14, which each have polished flats or faces 16 and 18 formed on their sides. These polished faces are disposed against each other so that a portion of the light energy propagating in the first optical fiber may be transmitted into the second optical fiber in a manner well known in the art. In one prior art embodiment consistent with FIG. 1, the coupler is configured as an optical amplifier. The first fiber 12 is a pumping fiber, and is coupled to light pumping sources 20 and 22 by optical transmission lines 21 and 23, respectively. The light pumping sources may be laser diodes, solid state lasers, or another suitable light energy source. While two light pumping sources 20, 22 are shown at each end of the pumping fiber in FIG. 1, it will be apparent that such a coupler can be used with only one light source. The second fiber 14 can comprise a signal fiber, receiving an optical communications signal through an input transmission line 13 and sending out an amplified optical signal through an output line 15, for example.

In a region of mating 24 of the two fibers, the signal fibers 12, 14 the signal fiber 14 is doped with lasing substances, such as neodymium, ytrium, or erbium. Light energy which transfers from the pumping fiber 12 into the signal fiber 14 in the region of mating 24 increases the energy of these lasing substances, such that when a signal in the signal fiber passes through the doped region, this signal stimulates light emissions from the lasing elements at the frequency of the signal. In this way a weak signal in the signal fiber is strengthened using the energy from the light pumping sources 20 and 22. In an amplifier as shown in FIG. 1, the direction of propagation of the energy in the pumping fiber is irrelevant. The important feature for this discussion is that energy is transferred into the signal fiber in the doped region, so as to increase the energy of the doping substances. For this reason, two pumping sources 20 and 22 may be disposed at opposing ends of the pumping fiber.

The maximum nominal efficiency that may be expected from such couplers is 50%. Those skilled in the art will recognize that with the coupler of FIG. 1 some light energy within each of the pumping sources 20 and 22 will continue past the mating region 24 and propagate toward the opposite pumping source, thus being wasted.

Advantageously, the inventors have developed a multimode coupler that is capable to transferring very large amounts of energy into a single fiber with relatively small losses. With this invention, for example tens, even hundreds of watts of energy could be transmitted into a single fiber, depending upon the capacity of the fiber. Referring to FIG. 2, one embodiment of a multimode coupler 28 in accordance with the present invention is shown. The coupler comprises a first multimode optical fiber 30 disposed within a first substrate 32, and a second multimode optical fiber 40 disposed within a second substrate 42. The first fiber 30 has a polished facet (or surface, or face) 34 on a side of a curved portion 36 of the fiber, the polished face being substantially coplanar with a mating side or surface 38 of the first substrate. The second fiber 40 has an angularly polished end 44, which is substantially coplanar with a mating side 46 of the second substrate.

The mating side 38 of the first substrate 32 is disposed adjacent and parallel to the mating side 46 of the second substrate 42, such that the polished end 44 of the second fiber 40 is disposed against the polished face 34 of the first fiber 30, and light energy propagating through the second fiber may pass into the first fiber. Those skilled in the art will recognize that an optically neutral lubricating compound such as OC-431A-LVP from Nye Optical Products can be disposed between opposing mating sides of the first and second substrates so as to facilitate light transfer.

The substrates 32 and 42 preferably comprise fused silica, in which the respective optical fibers 30 and 40 are embedded or affixed. The substrate and fiber are then polished together with a polishing lap in order to simultaneously form the flat mating side of the substrate, and the flat surfaces or faces on the respective optical fibers. The polished end 44 of the second fiber is polished at an angle α of from about 1 degree to about 6 degrees relative to the longitudinal axis 50 of the second fiber, and preferably at an angle of about 2.2 degrees. The inventors have found that this angle appears to provide the greatest light transfer efficiency. Since the numerical apertures of both the optical fiber and the double-clad-fiber inner cladding are nominally the same (about 0.22), the angle a must be very small (less than about 3 degrees) for efficient coupling. For angles less than about 2 degrees, however, the contact region between the fibers becomes prohibitively large, so that an optimal value of a equal to 2.2degrees was decided upon.

It will be apparent that the formation of the angled flat 44 on the end of the second fiber 40, which has a generally circular cross-section, will produce an elliptically shaped end face or surface, (similar to end face 144, shown in FIG. 4b). Similarly, polishing the face 34 on a side of the first optical fiber 30 approximately tangentially to a curved portion 36, will produce a semi-elliptical face, (similar to face 134, shown in FIG. 4b). While polished faces 44 and 34 may not have exactly the same size and shape, they can be formed such that they are close enough to the same size and shape for the purposes of this invention. Those skilled in the art will recognize that through careful control and selection of the diameter and angle of polish of the second fiber, and the diameter, radius of curvature, and depth of polish of the first fiber, the corresponding polished faces may be formed very nearly identical in size and shape.

With the mating sides of opposing substrates brought together, these faces 34 and 44 are brought into mating alignment in a mating region 48. The term “mating alignment” as used herein means that the polished faces 34 and 44 are drawn together with as much surface area of one face being disposed adjacent and parallel to as much surface area of the other face as possible, for maximum energy transfer. Where the polished faces are approximately the same size and shape, as is preferred, the edges of the polished faces will be substantially in alignment. As shown in FIG. 2, when in mating alignment the ends 44a and 44b of the polished end 44 of the second fiber 40 are approximately aligned with the ends 34a and 34b of the polished face 34 of the first fiber 30. When the polished faces are in mating alignment, there will be maximum energy transfer and transfer efficiency between the second fiber and the first fiber.

In operation, a first light pumping source 60 shown in FIG. 2 is connected to the first fiber 30 through a first transmission line 62, and a second light pumping source 64 is connected to the second fiber 40 through a second transmission line 66. The light energy in the first and second fibers propagates in the direction of arrows 68, and combines together in the mating region 48, and continues on, such as through an additional transmission line 70, in a light propagation direction indicated by arrow 72. Ultimately, the additional transmission line 70 may be connected to a light energy utilizing device 74, which receives and uses the light energy. There are a variety of light energy utilizing devices which may be associated with the invention, as discussed below. The inventors have found that the coupler configuration shown results in approximately 95% efficiency of transfer from the second fiber to the first.

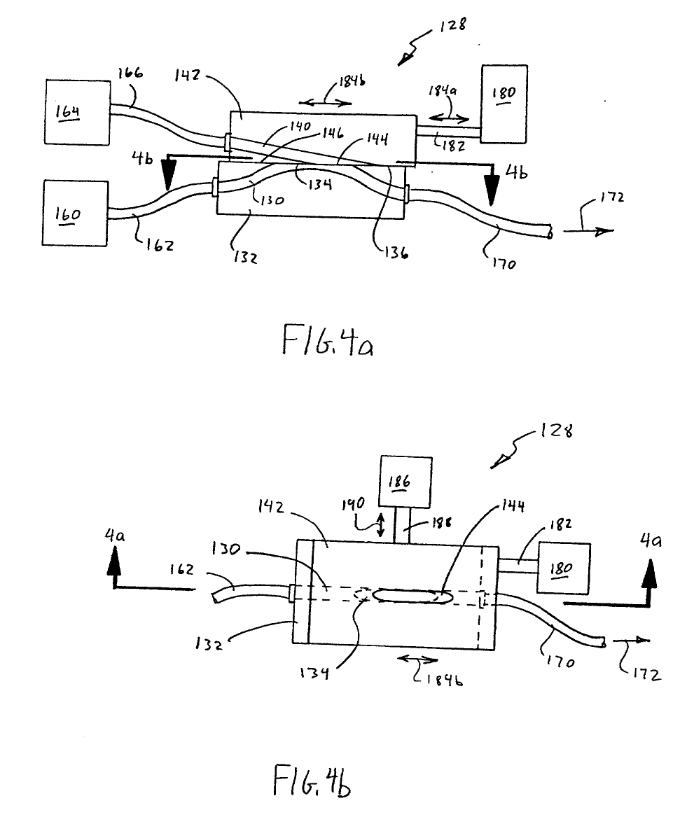

A plurality of couplers as depicted in FIG. 2 can be interconnected in a network or tree configuration so as to combine the energy of many pumping sources into a single fiber. The schematic diagram of FIG. 3 illustrates such a network 78 configured for combining light energy from many sources 80a, b, c, into a single fiber 70b using a plurality of multimode couplers 28a, b. In this embodiment, a first multimode coupler 28a has its first and second fibers 30a and 40a connected to light pumping sources 80a and 80b, respectively. The combined energy of pumping sources 80a and 80b is thus transmitted through transmission line 70a in a light propagating direction 72a. A second multimode coupler 28b has a second fiber 40b connected to a third light pumping source 80c, and a first fiber 30b connected to transmission line 70a. Consequently, coupler 28b combines the energy of the third pumping source with the energy in line 70a, which energy now represents the combined energy of three pumping sources. This combined energy continues down transmission line 70b, in the light propagating direction 72b ultimately connecting to a light energy utilizing device 74b, in a manner similar to that discussed above. In this manner, networks or trees of multimode couplers may be combined to pump large amounts of multimode light energy into a single fiber.

Optical fibers have been developed which are capable of carrying tens of watts. Using this coupling system 78 in accordance with the principles of the present invention, tens of watts of light energy can be pumped into a single fiber using light pumping sources which each provide only a much smaller amount of energy, such as just few watts. This network concept has possible application with a wide variety of light energy utilizing devices where a large amount of power is desired. For example, the combined energy from many light sources can be coupled into a communications fiber such as through a conventional amplifying coupler 10 as shown in FIG. 1, and described above, providing large signal amplification with a single amplifying coupler. As another example of a light energy utilizing device, a surgical laser requires a large amount of energy from a very small source. Because it is desirable to keep such instruments as small as possible, such as for endoscopic or endovascular surgery, it is preferable to use a single fiber, rather than a relatively bulky bundle of separate fibers. A network of couplers as described herein can combine energy from many light sources into a single fiber, which may be preferable for this application.

Another advantage of the invention is its “tunability” or adaptability to adjustment of light output from a given coupler. In an embodiment of the invention shown in FIGS. 4a and 4b, the coupler 128 comprises first and second substrates 132 and 142, which are translationally moveably coupled together, so that the alignment of the polished faces 134 and 144 may be selectively adjusted. As illustrated, the second substrate 142 is configured to translate side to side, in the direction indicated by arrows 184a and b, along a plane defined by the corresponding mating sides 136 and 146, so as to selectively vary the alignment of the polished faces 134 and 144. This movement is caused by a linear movement actuator 180, connected to the second substrate by a linkage 182. While FIG. 4a depicts the second substrate as being moveable, this depiction is relative. The two substrates may be configured in any manner which will allow one to translate with respect to the other, regardless of whether one or the other is fixed.

Light energy is provided to the first fiber 130 via a transmission line 162 from a light pumping source 160. Multimodal Light energy is provided to the second fiber 140 via transmission line 166 from light pumping source 164. When the polished faces 134 and 144 are taken out of optimal alignment, as shown, a larger portion of the light energy will be lost through the coupler, resulting in a lower energy in the light propagating direction 172 in output line 170. A top sectional view of the selective misalignment is provided in FIG. 4b, which provides a view normal to the plane of the mating sides 146 and 136, as described above. As shown in FIG. 4b, two linear movement actuators 180 and 186 may be provided in orthogonal relationship to each other to allow the second substrate to translate in orthogonal directions within the plane of the mating sides, as indicated by arrows 184b and 190.

By selectively varying the alignment of the polished faces, the efficiency of transmission of light from the second fiber to the first is selectively varied, or “tuned”. For example, using the tunable coupler shown in FIG. 4a and 4b, it may be desirable to produce a total energy output of exactly 5 watts using two 3 watt pumping sources. Without tunability, output line 170 would transmit energy of approximately 6 watts, rather than 5. Through tuning the coupler 128, the output can be adjusted or “tuned” to exactly 5 watts by misaligning the polished faces until the appropriate energy loss results in the desired output.

Those skilled in the art will recognize that the movement actuators 180 and 186 can be chosen from a number of types of actuator devices. We have used the MotorDrive™ Linear Actuators from Cohorent Auburn Group, Auburn, Calif. with a resolution of 0.1 μm. For example, the actuator may comprise an electrical servo, such as a solenoid, which provides reciprocal linear motion along a single axis. Alternatively, the actuator may be an electrical reciprocating gear drive or screw drive, such as a power operated micrometer like the ones we are using. As yet another alternative, the actuator may comprise a selectively deformable piezoelectric actuator which is coupled at one end to a fixed base (not shown) and at another end to the first or second substrate 132 or 142, such that when the piezoelectric material deforms in response to an electrical current, the substrate is caused to move.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An optical coupler system, comprising:
a first multimode optical fiber having a polished face on a side thereof, and
a second multimode optical fiber having an angularly polished end, said polished end being disposed in mating alignment with the polished face of the first optical fiber, whereby light energy propagating through the second fiber passes into the first fiber and combines with light energy propagating therein.

2. A system as in claim 1, wherein the polished end of the second fiber is polished at an angle of from about 1 degree to about 6 degrees relative to a longitudinal axis of the second fiber.

3. A system as in claim 2, wherein the angle at which the second fiber is polished is approximately 2.5 degrees relative to a longitudinal axis of the second fiber.

4. A system as in claim 1, wherein the polished face is disposed on a curved portion of the first fiber.

5. A system as in claim 1, further comprising:
a light energy source coupled to the second optical fiber, and configured for transmitting light energy thereinto; and
a light energy source coupled to the first optical fiber, whereby the light energy in the first fiber and the light energy in the second fiber combine in a light propagating direction in the first fiber.

6. A system as in claim 1, further comprising an actuator configured for moving the polished end of the second fiber relative to the polished face of the first fiber, so as to vary the efficiency of transmission of light energy between the second fiber and the first fiber.

7. A system as in claim 1, further comprising:
a first substrate within which the first fiber is disposed, the polished face being coplanar with a mating side of the first substrate;
a second substrate within which the second fiber is disposed, the polished end of the second fiber being coplanar with a mating side of the second substrate, the mating side of the first substrate being moveably disposed adjacent and parallel to the mating side of the second substrate; and
an actuator coupled to at least one of the first and second substrates, and configured for moving at least one of the first and second substrates relative to the other, so as to move the polished end of the second fiber relative to the polished face of the first fiber, so as to vary the efficiency of transmission of light energy therebetween.

8. A system as in claim 7, wherein the actuator is configured to translationally move at least one of the first and second substrates in the plane of the mating side thereof.

9. A system as in claim 7, wherein the actuator is selected from the group consisting of an electrical servo, a gear drive, a screw drive, and a selectively deformable piezoelectric actuator.

10. A system as in claim 1, further comprising a light energy utilizing device coupled to the first fiber.

11. A system as in claim 1, further comprising:
at least one additional polished face disposed on a side of the first fiber; and
at least one additional multimode optical fiber having an angularly polished end, said angularly polished end being disposed in mating alignment with the additional polished face of the first optical fiber, whereby light energy propagating through the at least one additional fiber is caused to pass into the first fiber and combine with light energy propagating therein.

12. A multimode optical coupler comprising:
a first substrate having a mating side;
a second substrate having a mating side;
a first multimode optical fiber disposed within the first substrate, the first multimode optical fiber having a polished face on a side thereof, said polished face being coplanar with the mating side of the first substrate; and
a second multimode optical fiber disposed within the second substrate, the second multimode optical fiber having an angularly polished end, said angularly polished end being coplanar with the mating side of the second substrate, the mating side of the first substrate being disposed adjacent and parallel to the mating side of the second substrate, whereby light energy propagating through the second fiber is caused to pass into the first fiber and combine with light energy therein in a light propagating direction.

13. The multimode optical coupler of claim 12, wherein the polished end of the second fiber is polished at an angle of from about 1 degree to about 6 degrees relative to a longitudinal axis of the second fiber.

14. The multimode optical coupler of claim 12, wherein: the first and second substrates are moveable with respect to each other; and further comprising:
an actuator coupled to at least one of the first and second substrates, and configured for translationally moving at least one of the first and second substrates with respect to each other parallel to a plane defined by the mating sides thereof, whereby the polished end of the second fiber may be moved relative to the polished face of the first fiber, so as to vary the efficiency of transmission of light energy therebetween.

15. An optical coupling network, comprising:
a first multimode optical coupler, comprising:
a first multimode optical fiber having a polished face on a side thereof;
a pumping fiber having an angularly polished distal end, the polished end of the pumping fiber being disposed in mating alignment with the polished face of the first optical fiber, whereby light energy propagating through the second fiber is caused to pass into the first fiber and combine with light energy therein in a light propagating direction; and
at least one additional multimode optical coupler, comprising:
at least one additional polished face on a side of the first optical fiber;
an additional pumping fiber, having an angularly polished distal end, the polished end of the pumping fiber being disposed in mating alignment with the additional polished face of the first optical fiber, whereby light energy propagating through the additional pumping fiber is caused to pass into the first fiber and combine with light energy therein in the light propagating direction.

16. The optical coupling network of claim 15, further comprising:
a plurality of light energy sources coupled to the first pumping fiber and additional pumping fibers associated with the at least one additional multimode optical coupler.

17. The optical coupling network of claim 15, wherein the polished faces on the sides of the first optical fiber are formed on a curved portion thereof.

18. A method of combining light energy within an optical fiber, comprising the steps of:
forming an optical flat on a side of a first optical fiber;
forming an angled flat surface on a distal end of a second optical fiber;
disposing the flat surface of the second optical fiber in mating alignment with the optical flat on the first fiber;
transmitting light energy into the first optical fiber;
transmitting light energy into the second optical fiber, such that the light energy propagating through the second fiber is caused to pass into the first fiber and combine with the light energy therein in a light propagating direction.

19. The method of claim 18, wherein the step of forming an angled flat surface on the distal end of the second optical fiber comprises forming a flat angled surface on the end of the second fiber at an angle of about 1 degree to about 6 degrees relative to a longitudinal axis of the second fiber.

20. The method of claim 18, further comprising the step of moving the polished end of the second fiber relative to the polished face of the first fiber, so as to vary the efficiency of transmission of light energy from the second fiber to the first fiber.
